(19) United States
(12) Patent Application Publication
(10) Pub. No.: US 2005/0079041 A1
(43) Pub. Date: Apr. 14, 2005

(54) HOISTING DEVICE FOR USE WITH OVERHEAD TRAVELING CARRIAGE SYSTEM

(75) Inventors: Philip L. Campbell, Millbrook, NY (US); Ray A. Reyes, New Windsor, NY (US); Uldis A. Ziemins, Poughkeepsie, NY (US)

Correspondence Address: HOFFMAN WARNICK & D'ALESSANDRO, LLC, 3 E-COMM SQUARE, ALBANY, NY, 12207, US

(73) Assignee: INTERNATIONAL BUSINESS MACHINES CORPORATION, Armonk, NY (US)

(21) Appl. No.: 10/605,606

(22) Filed: Oct. 13, 2003

(51) Int. Cl. B65G 1/00

(52) U.S. Cl. 414/626

(57) ABSTRACT

A hoisting method and device for use in an overhead traveling carriage system are disclosed. The hoisting device includes an engager for engaging an object and a linearly expandable structure coupling the engager to a base point. A single hoist member is coupled at a first end to the engager and at a second end to a motorized drum, coupled to the base point, for substantially vertically retracting and extending the single member. Since a single hoist member is used, the amount of precision machining and technician training are reduced. The linearly expandable structure includes at least one lazy-tong linkage or a telescoping structure, which provides sway stability and compactness. The invention may also include a six-degree adjustment structure that may include a feedback system for use with the linearly expandable structure to provide increased accuracy.

### BACKGROUND OF INVENTION

The present invention relates generally to hoisting, and more particularly to a hoisting device for use with an overhead traveling carriage system such as used in a semiconductor fabrication facility.

Semiconductor fabrication facilities use automation for delivery of wafers between processing stations that include bays therebetween. There are various methods of delivering and placing wafers or a wafer holding pod, sometimes referred to as a front opening unified pod (FOUP), at a load port of a processing station. One approach is disclosed in U.S. Pat. No. 5,765,703 to Shiwaku. In this disclosure, FOUPs are delivered via an overhead vehicle that is mounted to, and movable, on a rail that is positioned over the necessary load ports. The overhead traveling carriage includes a hoisting device to lower/raise the FOUP. Conventionally, hoisting devices use three cables to lower/raise the FOUP via, for example, a three-roller drive that is driven via a motor(s) and gearing.

Unfortunately, conventional hoisting devices that use cables present a number of problems. First, conventional hoisting devices do not provide sway stability. In particular, cables are very susceptible to sway and vibration during lowering of the FOUP. To address this issue, sway sensing systems have been employed to deactivate hoisting if sway is excessive. Sway sensing systems, however, create other problems such as false triggers that needlessly deactivate the hoisting device. Second, conventional cable hoisting devices require precision machining and high tolerance parts to provide the necessary synchronization of three rollers, gearing and motor(s). As a result, conventional hoisting devices are very expensive. Lastly, conventional hoisting devices require excessive amounts of time to assemble and align, and require a highly skilled technician to implement.

Another approach uses three window-blind type rollers to lower a FOUP, which provides better stability. The devices are available from companies such as PRI-Brooks, Daifuku and Shinko. These devices, however, still require high precision gearing and mechanisms to hoist the FOUP.

Another disadvantage of conventional hoisting devices is that accurate placement of a wafer holding pod is difficult when position adjustment of the wafer holding pod is only possible in two-degrees of motion, i.e., hoist (vertical) direction and a travel (rail) direction, but the wafer holding pod can move spatially in all six degrees of motion. That is, the wafer holding pod can move in the travel X, lateral Y, hoist Z, roll, pitch, and yaw directions. In addition, accurate placement is made more difficult by the fact that there is no physical connection, other than a number of non-rigid cables and distant floors, ceiling and walls, connecting the wafer holding pod relative to a load port.

In view of the foregoing, there is a need in the art for a hoisting system that overcomes the problems of the related art.

### SUMMARY OF INVENTION

The invention includes a hoisting method and device for use in an overhead traveling carriage system. The hoisting device includes an engager for engaging an object and a linearly expandable structure coupling the engager to a base point. A single hoist member is coupled at a first end to the engager and at a second end to a motorized drum, coupled to the base point, for substantially vertically retracting and extending the single member. Since a single hoist member is used, the amount of precision machining and technician training are reduced. The linearly expandable structure includes at least one lazy-tong linkage or a telescoping structure, which provides sway stability and compactness. The invention may also include a six-degree adjustment structure that may include a feedback system for use with the linearly expandable structure to provide increased accuracy.

A first aspect of the invention is directed to an overhead traveling carriage system for use in a semiconductor fabrication facility, the system including an overhead traveling carriage, the carriage comprising: a main body movably engaged with an elevated rail; a hoisting device including: an object engager for engaging an object; a linearly expandable structure coupling the object engager to the main body; and a hoist for hoisting the object engager.

A second aspect of the invention is directed to a method of hoisting a wafer holding pod in a semiconductor manufacturing facility, the method comprising the steps of: engaging an engager to the wafer holding pod to be hoisted; hoisting the engager while linearly directing the engager with a linearly expandable structure.

A third aspect of the invention is directed to a hoisting device comprising: an engager for engaging an object; a linearly expandable structure coupling the engager to a base point; a single hoist member coupled at a first end to the engager and at a second end to a motorized drum, coupled to the base point, for substantially vertically retracting and extending the single hoist member; and an adjustment system for adjusting the position of the linearly expandable structure relative to a load port in greater than two-degrees of motion.

The foregoing and other features of the invention will be apparent from the following more particular description of embodiments of the invention.

### BRIEF DESCRIPTION OF DRAWINGS

The embodiments of this invention will be described in detail, with reference to the following figures, wherein like designations denote like elements, and wherein:

FIG. 1 shows an overhead traveling carriage system according to the invention.

FIGS. 2A and 2B show a hoisting device used with the carriage system of FIG. 1 including a first embodiment of a linearly extendable structure in the form of a lazy-tong linkage.

FIGS. 3A, 3B and 3C show a variety of lazy-tong linkage arrangements.

FIG. 4 shows a detail of a couple of lazy-tong linkages.

FIG. 5 shows a canopy for use with the lazy-tong link-age(s).

FIG. 6 shows a second embodiment of a linearly extendable structure in the form of a telescoping structure.

FIG. 7 shows an alternative embodiment of a linearly extendable structure according to the invention.

### DETAILED DESCRIPTION

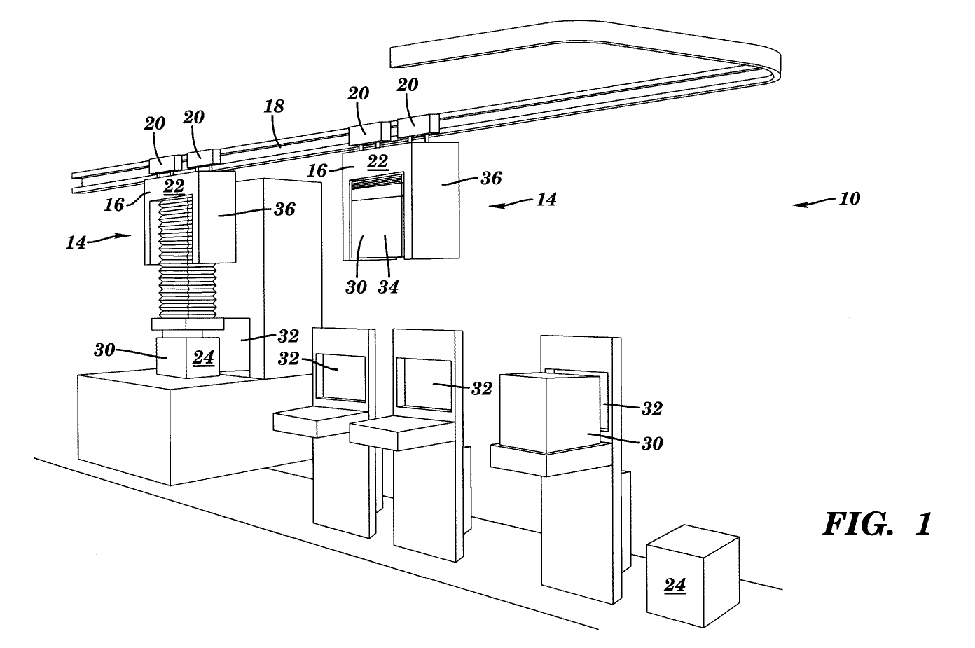

With reference to the accompanying drawings, FIG. 1 shows an illustrative overhead traveling carriage system 10 for use in a semiconductor fabrication facility.

System 10 includes at least one and, in most cases, a plurality of overhead traveling carriages 14. Each carriage 14 includes a main body 16 movably engaged with an elevated rail 18, and including a traveling motor(s) 20 for moving main body 16 along elevated rail 18. Main body 16 provides a base point 22 from which hoisting of an object, as will be described below, may occur. Elevated rail 18 may be supported in a variety of ways such as being hung from a ceiling of the facility or supported on poles. System 10 may also include a controller 24 for controlling a plurality of overhead traveling carriages 14 in the semi-conductor fabrication facility.

FIG. 1 also shows a plurality of objects 30 to be hoisted and moved by system 10 between various load ports 32 of any now known or later developed processing stations. In one embodiment, each object 30 includes a wafer holding pod 34 that may each hold a plurality of wafers (not shown). Wafer holding pod(s) 34 may take the form of a well-known front opening unified pod (hereinafter “FOUP”). As used herein, “hoist” or “hoisting” refers to the act of raising or lowering of an object 30. Each main body 16 may also include an object protector(s) 36 for enclosing and protecting a respective object 30 when raised to main body 16.

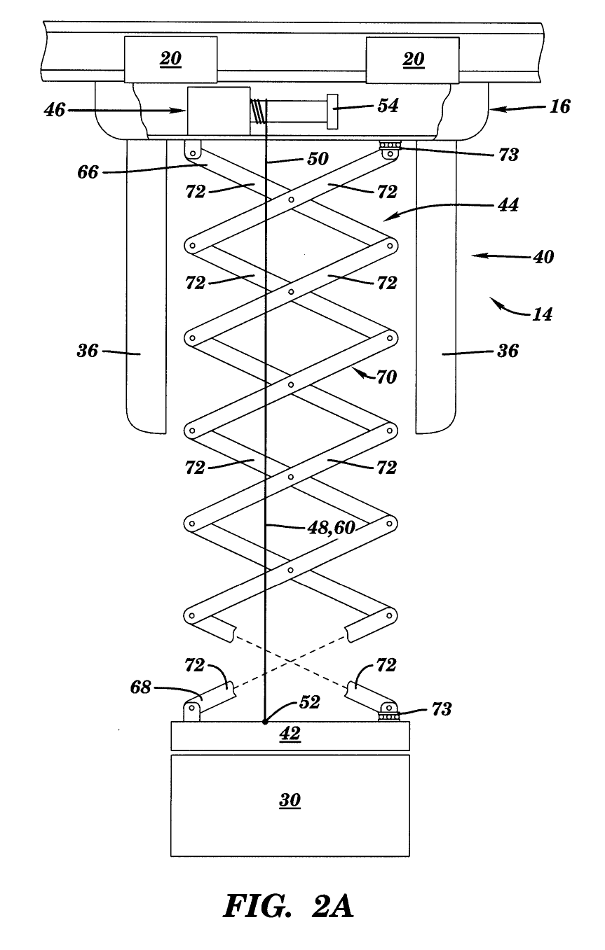

Referring to FIGS. 2A and 2B, each carriage 14 also includes a hoisting device 40 according to the invention. Each hoisting device 40 includes an object engager 42 for engaging an object 30, a linearly expandable structure 44 coupling object engager 42 to main body 16 and a hoist 46 for hoisting a respective object engager 42. Object engager 42 may be any now known or later developed mechanism for engaging and holding object 30 such as wafer holding pod 34. For example, object engager 42 may be a vacuum grasper that engages an object 30 by applying a vacuum to an upper surface thereof or a mechanical grasper.

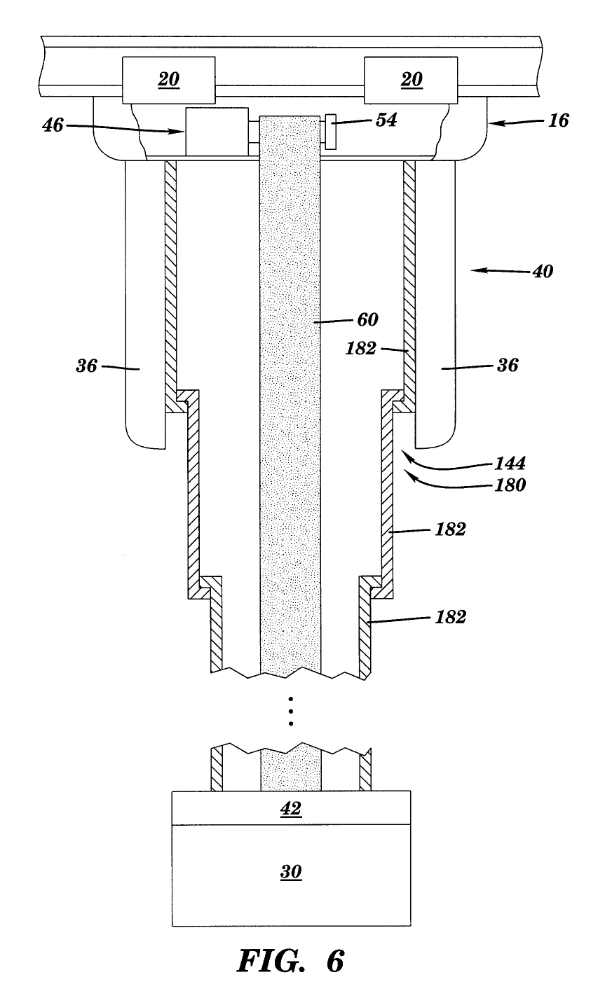

Hoist 46 includes a single hoist member 48 coupled at a first end 50 to object engager 42 and at a second end 52 to a motorized drum 54. Motorized drum 54 is coupled to main body 16 for retracting and extending single hoist member 48. In one embodiment, single hoist member 48 is provided as a cable 60, as shown in FIGS. 2A and 2B. In a second alternative embodiment, shown in FIG. 6, single hoist member 48 is provided as a belt 60. It should be recognized, however, that single hoist member 48 may be provided as any of now known or later developed mechanism for linearly moving an object 30 so long as it is structurally compatible with linearly extendable structure 44. Hoist 46 may also include other components such as positioning rollers (not shown), as necessary, for proper positioning and operation of single hoist member 48.

Linearly extendable structure 44 is coupled at an upper end 66 to main body 16 and at a lower end 68 to object engager 42, and is linearly extendable from main body 16. Linearly extendable structure 14 is used to, among other things, provide some rigidity to the hoisting movement against sway of object 30. In a first embodiment, shown in FIGS. 2A and 2B, linearly extendable structure 44 is provided as at least one lazy-tong linkage 70. Each lazy-tong linkage 70 (sometimes referred to as an “accordian linkage”) includes any number of pivotally coupled links 72 that are configured to linearly expand and contract in a scissor-like fashion. Since each lazy-tong linkage 70 is fairly rigid in the plane in which it rests, each linkage resists movement within the plane. In this embodiment, each link 72 adjacent upper end 66 and lower end 68 are pivotally coupled to main body 16 and object engager 42, respectively, in any known fashion. One link 72 at each end of each lazy-tong linkage 70 includes a sliding bearing 73 connection to main body 16 or object engager 42 to allow expansion/contraction of the linkage within the plane of movement.

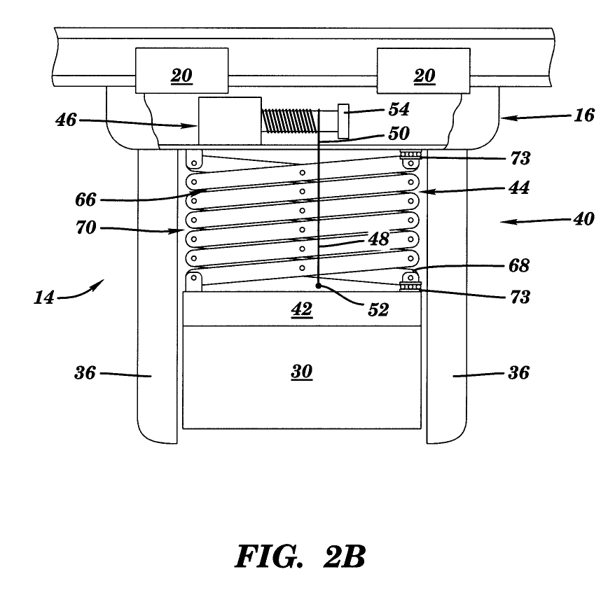

Referring to FIGS. 3A, 3B and 3C, in order to provide substantial rigidity against sway, a number of lazy tong linkages 70 may be implemented simultaneously. FIG. 3A conceptually illustrates implementation of two linkages 70A, 70B arranged in a non-parallel fashion to one another, which provides three connection points 74A-74C to object engager 42 and main body 16 and, hence, provides substantial resistance to sway. FIGS. 3B and 3C illustrate embodiments in which linearly expandable structure 44 includes at least three lazy-tong linkages 70. In particular, FIG. 3B conceptually illustrates implementation of three linkages 70A, 70B, 70C, arranged in a non-parallel fashion to one another, which provides three connection points 74A-74C to object engager 42 and main body 16. The FIG. 3B arrangement may provide further resistance to sway compared to the FIG. 3A arrangement. FIG. 3C conceptually illustrates implementation of four linkages 70A, 70B, 70C and 70D arranged substantially perpendicular to one another, which provides four connection points 74A-74D, and may provide further resistance to sway compared to the FIGS. 3A and 3B arrangements.

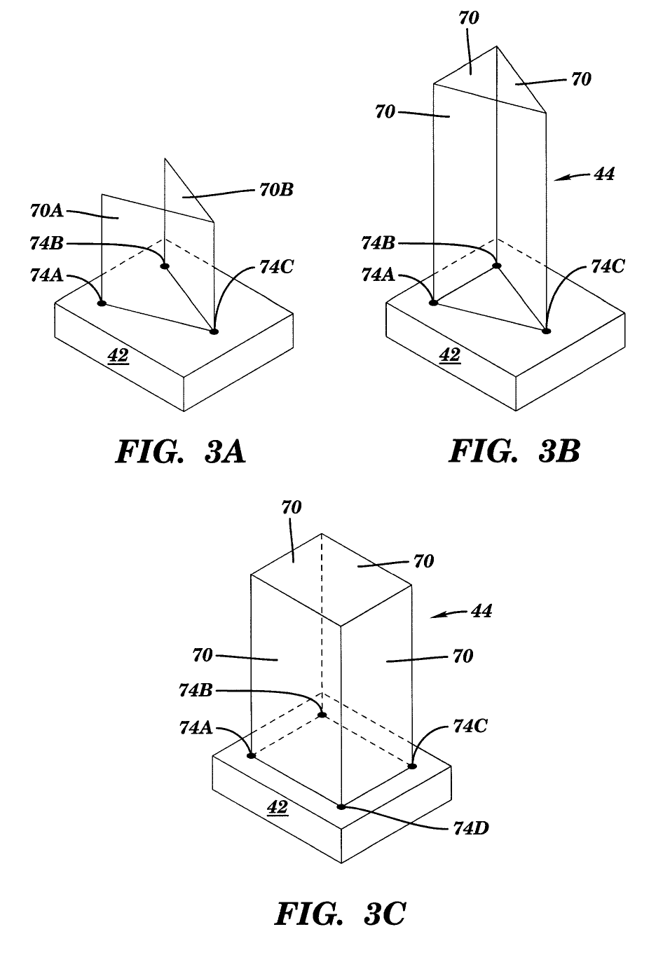

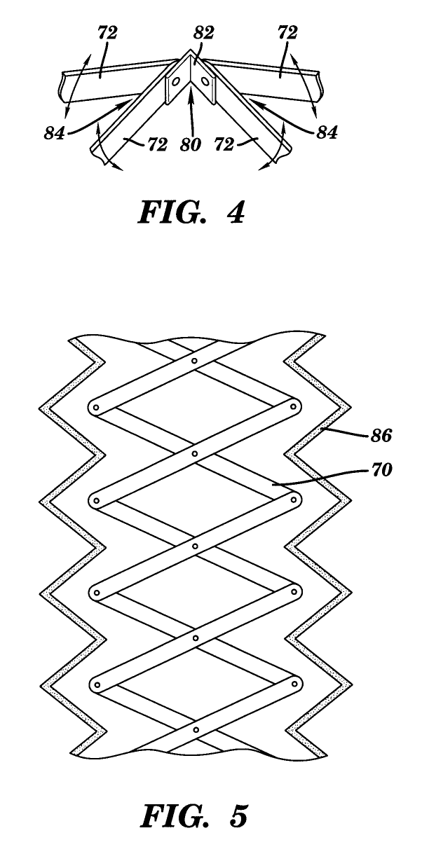

Referring to FIGS. 4 and 5, additional optional embodiments for lazy-tong linkage(s) 70 are shown. In FIG. 4, links 72 of adjacent lazy tong linkages 44 may be coupled together by a coupling 80 to assure mimicking movement of adjacent links 72 and provide further rigidity against sway. Coupling 80, as shown, includes an angled member 82 that is pivotally pinned through openings in, or adjacent to, joints 84 of links 72. Other mechanisms of coupling adjacent links 72 together may also be possible. In FIG. 5, a canopy 86 may be provided about lazy-tong linkage(s) 70 for protection and other purposes.

In an alternative second embodiment, shown in FIG. 6, a linearly expandable structure 144 is provided as a telescoping structure 180. Telescoping structure 180 may include a number of telescoping members 182 that linearly expand and retract, and provide some rigidity to the hoisting movement against sway, of object 30.

Returning to FIGS. 2A and 2B, in operation, object engager 42 engages an object 30 such as a wafer holding pod 34 to be hoisted as shown in FIG. 2A. As shown in FIG. 2B, object engager 42 can be hoisted using hoist 46 while object engager 42 and, hence, object 30, is linearly directed with linearly expandable structure 44, 144. Single hoisting member 48 runs down the middle of linearly extendable structure 44, 144. As object 30 is hoisted, linearly extendible structure 44, 144 folds inside of itself and folds to a shallow stacked height, as shown in FIG. 2B. The size of linearly extendable structure 44, 144, and the number of link 72 pairs or telescoping members 182, will depend on the drop height. For example, for an approximately ninety inch drop height, a lazy-tong linkage may use 12-15 linkage members that are 10-12 inches long and up to half an inch in width. Linearly extendable structure 44, 144 may be made of various synthetic materials that are lightweight and have a high modulus of strength and rigidity. Since the invention requires a single motorized drum central to linearly extendable structure 44, 144, few high tolerance machined parts are required and the system is easy to assemble and align.

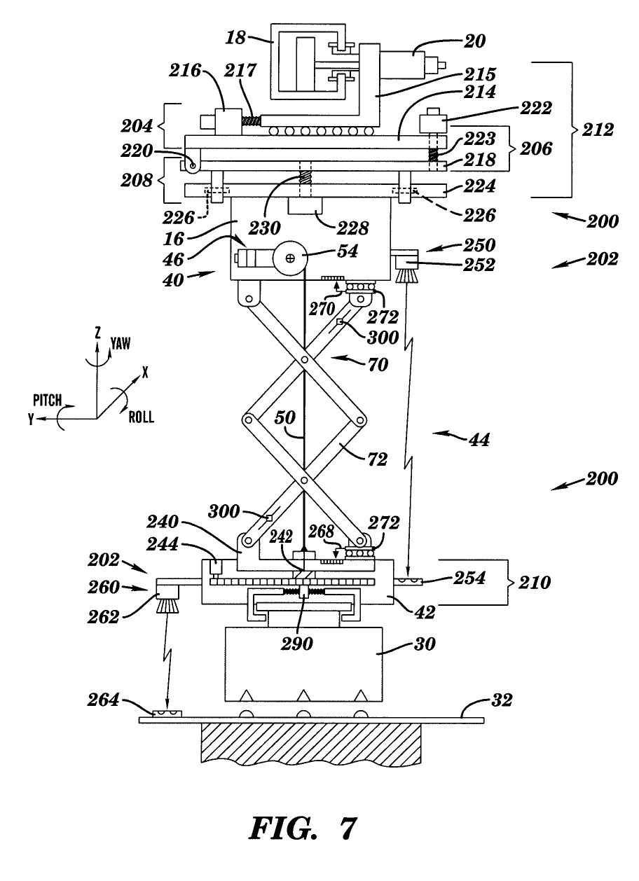

Turning to FIG. 7, an alternative embodiment of a linearly extending structure according to the invention is shown. As noted above and as shown in FIG. 7, a carriage 14, i.e., main body 16, moves spatially in all 6 degrees of freedom, i.e., travel X, lateral Y, hoist Z, roll, pitch, and yaw. In this embodiment, linearly extending structure 44 is provided as part of a six-degree adjustment system 200, which may include a feedback system 202. Adjustment in the hoist Z direction is provided, as described above, via hoisting device 40 including, inter alia, hoist 46, cable 50 and motorized drum 54, and in the travel X direction by traveling motor 20. Adjustment is provided by adjustment system 200 greater than two-degrees of motion: in a lateral Y direction by a lateral adjuster 204, in a roll direction by a roll adjuster 206, in a pitch direction by a pitch adjuster 208, and in a yaw direction by a yaw adjuster 210.

Lateral, roll and pitch adjusters 204, 206, 208 are provided by a three-directional adjustment structure 212 that is coupled to traveling motor 20 to support main body 16 and control the position of object engager 42 relative to load port 32. Adjustment structure 212 includes a number of members 214, 215, 220, 230 for allowing lateral, roll and pitch adjustments. First, adjustment structure 212 includes a lateral adjustment member 214 that is coupled to a motor coupling member 215 that is coupled to traveling motor 20. Lateral adjustment member 214 is adjustably positionable relative to motor coupling member 215, and hence load port 32, via an actuator 216 and gear 217 combination, e.g., an electric servomotor and worm gear, to provide lateral adjuster 204. Second, adjustment structure 212 includes a roll adjustment member 218 that is pivotally coupled to lateral adjustment member 214 about an axis 220 that is substantially aligned with a travel X direction. The pivotal position of roll adjustment member 218 relative to lateral adjustment member 214, and hence load port 32, is adjustable via an actuator 222 and gear 223 combination, e.g., an electric servomotor and worm gear, to provide roll adjuster 206. Third, adjustment structure 212 includes a pitch adjustment member 224 that is fixed to main body 16 and is pivotally coupled to roll adjustment member 218 about an axis 226 that is substantially aligned with a lateral Y direction. The pivotal position of pitch adjustment member 224 relative to roll adjustment member 218, and hence load port 32, is adjustable via an actuator 228 and gear 230 combination, e.g., electric servomotor and worm gear, to provide pitch adjuster 208. Roll and pitch adjuster 206, 208 allow for compensation for imperfections in the mounting of rail 18, among other causes of roll and pitch.

In one embodiment, yaw adjuster 210 is incorporated as part of object engager 42. Yaw adjuster 210 includes a yaw adjustment member 240 is pivotally coupled to lazy-tong linkage 70, and rotatably coupled to object engager 42 about a substantially vertical axis 242. Adjustment of yaw adjustment member 240, and hence object engager 42, about substantially vertical axis 242 is possible via actuator 244 and gear(s) 246 combination, e.g., electric servomotor and gearing. Also shown in object engager 42 is a grasping actuator 290 for grasping object 30, as is known in the art.

Feedback system 202 may include a number of sensors, as will now be described, that each feed to controller 24. First, a hoist position sensor 250 may be provided to determine the position of object engager 42 relative to main body 16. Hoist position sensor 250 may include a camera, laser, optical device, etc., 252 and a corresponding fiducial 254 to which it is to be aligned. Second, an engager position sensor 260 may be provided to determine the position of object engager 42 relative to load port 32. Engager position sensor 260 may include a camera, laser, optical device, etc., 262 and a corresponding fiducial 264 on load port 32 (or a fixed position relative thereto) to which it is to be aligned. Third, one or more linear optical encoders 268, 270 may be implemented to measure the movement of linkages 72. The information gathered by optical encoders 268, 270 can be used to determine hoisting distance and the differential movement of object engager 42 relative to main body 16. In this case, in addition to the above-described adjustment system 200, in another alternative embodiment, one or more ends of a linkage 72 that is/are coupled to main body 16 and object engager 42 may be coupled thereto via a linear bearing 272 to allow for limited movement in a folding direction of the linkage. In addition to the above-described sensors, each actuator 20, 46, 216, 222, 228, 244 and 290 includes a rotary encoder for closed loop position identification (PID) feedback. Each actuator also includes a “normally-on” brake to prevent motion when power is removed from the motors. Another sensor(s) 300 in the form of a strain gauge(s) can also be provided on various linkages 72 to sense and detect deflections in the linkages. The above-described sensors are used to adjust the position of object engager 42 relative to load port 32, and allow for accurate positioning of object 30 via feedback and control by controller 24. In particular, the above-described adjustment system 200 and feedback system 202 allow for accuracy up to +/−2 mm in X and Y directions, and 0.5 degrees in yaw, pitch and roll directions relative to the exact center of load port 32.

It should be recognized that while a particular structure of adjustment system 200 and feedback system 202 have been described herein that a variety of alternatives exist to provide the same functionality, which are considered within the scope of the invention.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

1. An overhead traveling carriage system for use in a
semi-conductor fabrication facility, the system including an overhead traveling carriage, the carriage comprising:
a main body movably engaged with an elevated rail;
a hoisting device including:
an object engager for engaging an object;
a linearly expandable structure coupling the object engager to the main body; and
a hoist for hoisting the object engager.

2. The system of claim 1, wherein the linearly expandable structure includes one of: at least one lazy-tong linkage and a telescoping structure.

3. The system of claim 2, wherein the linearly expandable structure includes at least three lazy-tong linkages.

4. The system of claim 1, wherein the hoist includes a single hoist member coupled at a first end to the object engager and at a second end to a motorized drum, coupled to the main body, for retracting and extending the single hoist member.

5. The system of claim 4, wherein the single hoist member is one of a cable and a belt.

6. The system of claim 1, further comprising a six-degree adjustment system for adjusting the position of the object engager in up to six-degrees of motion.

7. The system of claim 2, further comprising a plurality of sensors for feedback to a controller for adjusting the position of the object engager relative to a load port.

8. The system of claim 2, wherein the adjustment system includes a three-direction adjustment structure allowing adjustment of the object engager in a lateral, yaw and pitch direction relative to a load port.

9. The system of claim 1, wherein the object engager includes at least one of: a vacuum grasper and a mechanical grasper, for engaging the object for hoisting.

10. A method of hoisting a wafer holding pod in a semiconductor manufacturing facility, the method comprising the steps of:
engaging an engager to the wafer holding pod to be hoisted;
hoisting the engager while linearly directing the engager with a linearly expandable structure.

11. The method of claim 10, wherein the linearly expandable structure includes one of: at least one lazy-tong linkage and a telescoping structure.

12. The method of claim 10, wherein the hoisting step includes hoisting the wafer holding pod using a single hoist member coupled at a first end to the engager and at a second end to a motorized drum, coupled to a base point, for retracting and extending the single hoist member.

13. The method of claim 12, further comprising the step of controlling the position of the object engager in greater than two-degrees of motion.

14. A hoisting device comprising:
an engager for engaging an object;
a linearly expandable structure coupling the engager to a base point;
a single hoist member coupled at a first end to the engager and at a second end to a motorized drum, coupled to the base point, for substantially vertically retracting and extending the single hoist member; and
an adjustment system for adjusting the position of the linearly expandable structure relative to a load port in greater than two-degrees of motion.

15. The hoisting device of claim 14, wherein the linearly expandable structure includes at least two lazy-tong linkages having respective joints coupled to one another.

16. The hoisting device of claim 15, wherein the linearly expandable structure includes a canopy for enclosing the at least two lazy-tong linkages.

17. The hoisting device of claim 14, wherein the base point is positioned on a main body of an overhead traveling carriage, and the main body is movably engaged with an elevated rail.

18. The hoisting device of claim 14, wherein the adjustment system includes a three-direction adjustment structure allowing adjustment of the linearly expandable structure in a lateral, yaw and pitch direction relative to the load port.

19. The hoisting device of claim 18, wherein the adjustment system further includes a yaw adjuster for adjusting a position of the engager about a substantially vertical axis.

20. The hoisting device of claim 14, further comprising a feedback system for determining the position of the linearly extendable structure.
